(19) United States
(12) Patent Application Publication
(10) Pub. No.: US 2016/0160930 A1
(43) Pub. Date: Jun. 9, 2016

(54) Connecting Device

(71) Applicant: Robert Russell, Attleborough (GB)

(72) Inventor: Robert Russell, Attleborough (GB)

(21) Appl. No.: 15/014,467

(22) Filed: Feb. 3, 2016

Related U.S. Application Data
(63) Continuation of application No. 14/649,051, filed on Jun. 2, 2015.

(51) Int. Cl. F16D 1/112

(52) U.S. Cl. CPC F16D 1/112

(57) ABSTRACT

A male shaft connector for connecting manually- or mechanically-driven rotating shafts, the male connector having a male mating section with a non-circular external cross-section perpendicular to the axis of a shaft to be connected; a locking peg moveable between a first position wherein the peg protrudes from the surface of the mating section and a second position wherein the outermost surface of the peg is substantially flush with the surface of the male mating section; and biasing means to bias the peg towards its first position; and a shaft mounting section attached to the male mating section. Provision of an angled portion on the peg causes the peg to be automatically depressed when male and female connectors are joined. Also provided is a corresponding female shaft connector, having a cavity to receive a male mating section from a corresponding male shaft connector.

### FIELD OF THE INVENTION

The invention relates to connectors for connecting shafts or rods intended to be regularly and releasably coupled to each other and manually- or mechanically-driven to rotate about their common axis. Such shafts are typically used to clean or unblock conduits such as chimneys, drains, flues and ducts (e.g. air-conditioning or ventilation ducts) by attaching an appropriate tool to the end of an array of (continually coupled) shafts. Such shafts are usually flexible to enable them to be used in curving conduits, and to allow them to be introduced into conduits, but they can also be rigid, depending on the particular application of use.

### BACKGROUND AND PRIOR ART

U.S. Pat. No. 6,688,800 describes a coupling device for shafts of this nature, having a spring-biased plunger in one part of the coupler that emerges from the surface of a male coupling part and that may be depressed by an operator to connect a corresponding female coupling part. Once connected, the plunger is biased by the spring to engage with a corresponding hole located in the wall of the female coupling part. To disengage the connector, an operator may again push the plunger against the action of its biasing spring, allowing the two connector parts to be separated.

The present invention is an improvement on this type of connector and seeks to address some shortcoming of this known device. Firstly, it has been found that connection of two shafts fitted with these couplers can be a little difficult because the plunger needs to be depressed by the operator in order to allow the connection to be made. The shafts are often used in situations where the operator wears gloves, and the need to depress the plunger with a gloved hand in order to make a connection can make it difficult to quickly add a further shaft onto the shaft array. Also the shafts are often used in conditions of low light, a dirty environment, and poor access. Connection of one shaft to another requires that, not only must the plunger be depressed to make the connection, but the shafts must be correctly rotationally aligned such that the plunger mates with the corresponding hole in the female connector to ensure a secure connection is made. There are situations where the plunger might only partially return to its biased position, with just one edge of the plunger engaged with the hole. The operator might hear a click as this partial engagement occurs, and be unaware that the connection has not been properly made. Once the shaft has been pushed into a conduit, the connection is, of course, no longer visible and rotation of the shaft, or a change of direction of the shaft rotation can cause the shafts to become disconnected as the plunger disengages from the hole. This is a particularly difficult situation to remedy, and the operator is left with a disconnected array of shafts and associated tools connected to the shafts located within an inaccessible duct. This often requires a drain to be excavated or ductwork to be dismantled to enable the shafts to be recovered.

Furthermore, the rotational forces that need to be transmitted along the shaft array are transferred from shaft to shaft by the abutment of one face of the plunger to a corresponding face of its mating hole. If and when the rotational direction is reversed, force transfer occurs through the corresponding other face of the plunger. Repeated force transmission in this fashion can cause the edges of the plunger to wear to such an extent that rotational forces, combined with flexing of the shaft array, can cause the plunger to become disengaged from the hole in the corresponding connector leading to decoupling of the shafts. This again poses significant problems for recovery of the disconnected shaft array and associated tools.

### SUMMARY OF THE INVENTION

Accordingly, the invention provides, in a first aspect, a male shaft connector for connecting manually- or mechanically-driven (preferably mechanically-driven) rotating shafts, said male connector comprising: a male mating section having a non-circular external cross-section perpendicular to the axis of a shaft to be connected; a locking peg located within said male mating section and moveable between a first position wherein said peg protrudes from the surface of said mating section and a second position wherein the outermost surface of said peg is substantially flush with the surface of said male mating section; biasing means to bias said peg towards said first position; and a shaft mounting section attached to said male mating section.

The provision of a male connecter (and as will be described below, a corresponding female connector) having a non-circular cross-section is advantageous because the rotational forces that have hitherto been transferred between adjacent connected rods or shafts by means of the “plunger” can now be transferred between adjacent shafts by the non-circular, and therefore non-rotatable, connection between corresponding male and female connectors. The “plunger” or peg is now no longer the only mechanism for transfer of rotational forces between adjacent rods or shafts in a connected array. Furthermore, by choosing a shape, for the non-circular cross-sections that can only be mated in one position (i.e. have no rotational symmetry), a further advantage is gained in that the biased locking peg can be arranged to always be correctly aligned with the corresponding peg-receiving aperture in the female mating section. In this way, secure locking of the connector is ensured.

Preferably the protruding surface of said peg includes an angled portion such that the edge of the peg furthest from the shaft mounting section is substantially flush with, or recessed below, the surface of said male mating section such that insertion of the male mating section into the cavity of a corresponding female mounting section causes the peg to move towards its second position. In this way, the two connectors may be simply pushed together, and the lip of the cavity in the female connector will act against the angled surface, thereby depressing the locking peg and allowing the connection to be made.

It is further preferred that the protruding surface of said peg includes a flat portion perpendicular to the axis of movement of said peg between its first and second positions. This provides a flat surface against which a user can push to move the peg into its second position in order to disconnect the connectors.

It is also preferred that in the male connector, the cross-section of said male mating section perpendicular to the axis of a shaft to be connected comprises a circle with a missing segment. This configuration is relatively straight-forward to manufacture, and provides the lack of non-rotational symmetry to ensure alignment of the locking peg and aperture.

In this case, it is also preferred that said locking peg is located on the flat portion of said male mating section corresponding to the chord defining said missing segment. This ensures that the peg passes through the thickest portion of the aperture in the corresponding female connector, thereby giving a stronger connection for rotational torque transmission (so that the shafts do not disconnect without the operator depressing the locking peg).

It is further preferred that the faces of said locking peg parallel to the axis of a shaft to be connected comprise flat surfaces. The use of fiat faces ensures a greater surface area of contact for transmission of any rotational forces not transferred via the non-circular mating elements, in use, should there be some slack in the joint.

It is also preferred that the face of said locking peg perpendicular to the axis of a shaft to be connected, and furthest away from said shaft mounting section comprises a flat surface. By contrast to the device in U.S. Pat. No. 6,688,800 which has a rounded-end “plunger”, this provides a larger surface area for axial force transmission when the rod array is moved into or out of a conduit.

In a second related aspect, the invention also provides a female shaft connector for connecting manually- or mechanically-driven (preferably mechanically-driven) rotating shafts, said female connector comprising: a shaft mounting section; a female mating section comprising a cavity to receive a male mating section from a corresponding male shaft connector, said cavity having a non-circular cross-section perpendicular to the axis of a shaft to be connected; and an aperture extending from the interior of said cavity to the exterior of said female mating section to receive a locking peg from a corresponding male shaft connector.

Preferably, the non-circular cross-section of said aperture comprises a circle with a missing segment for reasons corresponding to those for the equivalently-shaped male connector.

The invention also provides a shaft connection system comprising a male shaft connector described herein and a female shaft connector as described herein, wherein each such connector has a correspondingly shaped mating section.

The invention further provides a shaft comprising: an elongate shaft member; a male shaft connector described herein affixed to one end; and a female shaft connector as described herein affixed to the other end.

Also included within the scope of the invention is a shaft connector, shaft connection system or shaft substantially as described herein, with reference to and as illustrated by any appropriate combination of the accompanying drawings.

### BRIEF DESCRIPTION OF THE FIGURES

The invention will be described with reference to the accompanying drawings, in which:

FIG. 1 shows an axial cross-sectional view of a male connector;

FIGS. 2A to 2C show details of a locking peg;

FIG. 3 shows an axial cross-sectional view of a female shaft connector;

FIG. 4 shows a radial cross-sectional view of a female connector;

FIG. 5 shows a plan view of a female connector;

FIG. 6 shows a radial cross-section of a female connector;

FIGS. 7 and 8 show a radial cross-sectional view of connected male and female connectors;

FIG. 9 shows a plan view of a male connector;

FIG. 10 shows a radial cross-section of a male connector;

FIG. 11 shows an axial cross-section of a male and female connector;

FIG. 12 shows an axial cross-section of a male connector; and

FIGS. 13 to 15 show cross-sections of a selection of embodiments of female connectors.

### DESCRIPTION OF PREFERRED EMBODIMENTS

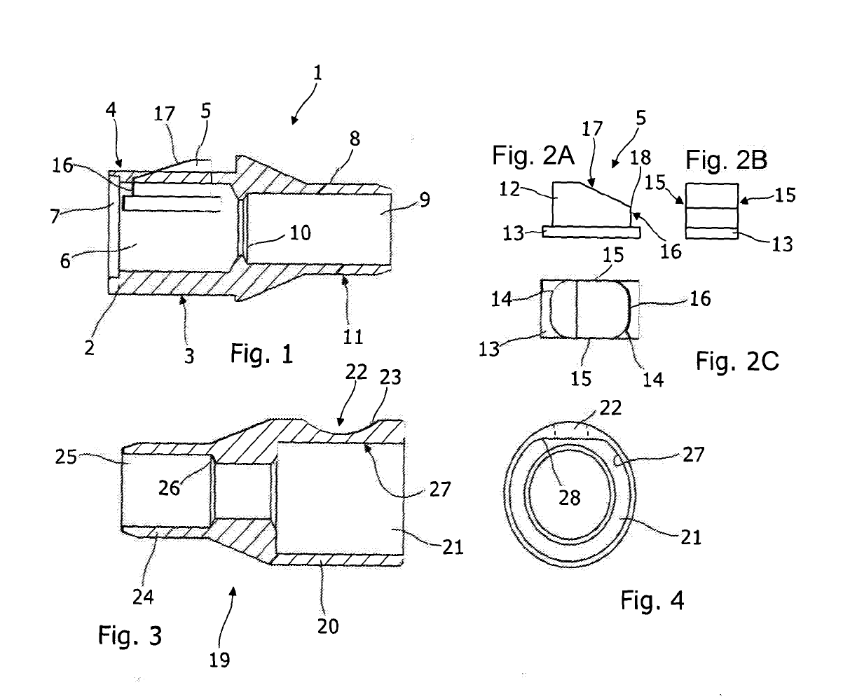

FIG. 1 illustrates, in axial cross-sectional view, a male shaft connector according to an aspect of the present invention, generally indicated by 1. The connector has a male mating section 2 that has a non-circular cross-section of the external surface 3 of the mating part. In this embodiment, the external surface 3 is formed as a cylindrical surface with flat face 4. The external cross-section is thus in the form of a circle with a missing segment (a “D-shaped” cross-section). The connector 1 also has a locating peg 5 mounted in a hole on the male mating section 2. There is a cavity 6 within the connector to house a biasing element, such as a spring (not illustrated) to bias the peg 5 in an outward radial direction. Preferred configurations of the peg are described below. The cavity 6 is sealed with an end cap 7 to prevent ingress of dirt that might cause malfunction of the biasing element. The connector 1 also has a shaft mounting section 8 to enable the connector to be mounted onto a shaft in an essentially permanent fashion. In this embodiment, the shaft mounting section 8 comprises a cylindrical hole 9 so sized as to receive the end of a shaft and an abutment region 10 against which the shaft can abut. The shaft can then be fixed to the connector by e.g. use of a pin driven through the side 11 of the shaft mounting section, crimping the shaft mounting section, or by the use of an appropriate adhesive. Typically the shaft connector 1 will be made of steel, with an appropriate surface finish (such as an electroplated finish) to prevent corrosion, or be made of aluminium.

FIGS. 2A-2C illustrate in side elevation, end elevation and top plan view respectively, a locking peg 5 for use in the present invention. The peg 5 has the form of a button portion 12 mounted on a flange 13. The button portion 12 protrudes through a correspondingly shaped hole in the surface of the male mating section 2, whilst the flange element 13 serves to keep the peg 5 captive in the male connector against the biasing force of the biasing element. The button has generally rectangular plan cross-section with rounded corners 14 as seen in FIG. 2C. The generally rectangular cross-section provides flat surfaces 15 parallel to the axis of a shaft to be connected, and also a flat surface 16 perpendicular to the axis of a shaft to be connected and furthest away from the shaft mounting section 8, once assembled into the connector.

The top, or outermost (when assembled) surface of the peg 15 comprises an angled portion 17 such that, when assembled, the leading edge 18 of the peg (i.e. the edge of the peg furthest from the shaft mounting section 8) is substantially flush with, or even recessed below, the surface of the male mating section. In this way, when the male and female portions are pushed together, the female connector serves to depress the peg 5 against its biasing element, allowing the two connectors to be mated. The non-circular cross-section of the mating surfaces of the two connectors ensures that the peg and the corresponding hole in the female connector are lined-up and prevents relative rotational movement of connectors.

FIG. 3 illustrates, in axial cross-sectional view, a female shaft connector of the present invention, generally indicated by 19. The connector 19 has a female mating section 20 comprising a cavity 21 having a non-circular internal cross-section perpendicular to the axis of a shaft to be connected. The mating section also includes an aperture 22 extending through the wall of the mating section between the cavity 21 and the exterior, so sized and shaped to receive the external portion of the locking peg 5 of a corresponding male connector 1. The external surface of the mating section is also provided with a cutout 23 surrounding the aperture 22 to enable the peg to be more easily depressed to facilitate disengagement of connectors.

The internal surface 27 of the cavity 21 has a non-circular cross-section. In this embodiment, the cross-section has the form essentially of a circle with a missing segment. There is, therefore, a flat portion 28 that corresponds to the flat surface 4 on a corresponding male connector. This is shown in radial cross-sectional view in FIG. 4, in which corresponding features are numbered identically.

The female connector 19 is also provided with a shaft mounting section 24. This again comprises a shaft-receiving cavity 25 and a shaft abutment region 26. In a corresponding fashion as for the male connector 1, a shaft may be inserted into the cavity 25, abutting the abutment section 26 and be secured there, in an essentially permanent fashion, using means such as a pin, crimping or a suitable adhesive.

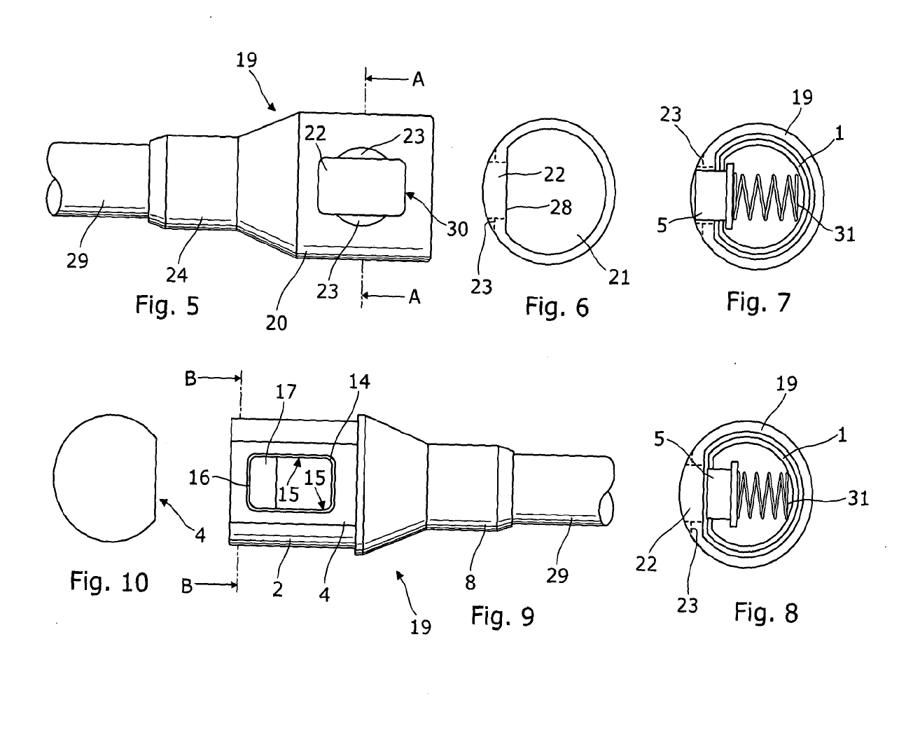

FIG. 5 shows, in plan view, a female shaft connector 19 of the present invention connected to the end of a shaft 29. FIG. 6 is a cross-section through the connector at position A-A and has correspondingly-numbered elements. This view shows the aperture 22 between the exterior of the connector and the cavity 21. The aperture is shaped to receive a locking peg from a corresponding mate connector, and in preferred embodiments has a flat region 30 to abut with a corresponding flat region 16 of a locking peg 5, thereby reducing the point loads on the connector in the face of axial tension in a rod or shaft array. Also illustrated is the cutout 23 provided to facilitate depression of a locking peg 5. It can be seen in FIG. 6, that the cavity 21 of the connector has a non-circular cross-section, in this embodiment in the form of a flat face 28 in an otherwise circular cross-section.

FIG. 7 illustrates a cross-section through a female connector 19 at position A-A in FIG. 5, when mated with a male connector 1 and with the locking peg 5 biased to its first position by means of a biasing element in the form of a coil spring 31.

FIG. 8 shows the cross-section of FIG. 7, but with the locking peg 5 depressed to a position against the biasing force such that the male connector 1 may be inserted into the female connector 19.

FIG. 9 shows, in plan view, a male connector 1 connected to a shaft 29 by its shaft mounting section 8. The male mating section 2 is again of non-circular external cross-section, having the shape illustrated in FIG. 10 of a circle with a missing segment, thereby leaving a flat face 4. FIG. 10 is a cross-section through the line B-B of FIG. 9. The locking peg 5 is shown protruding through a hole located in the flat face 4 of the male mating section 2. The peg has a generally rectangular plan view, with rounded corners but presenting flat faces 15 parallel to the axis of the shaft 29 and a flat face 16 perpendicular to the axis of the shaft 29. An angled portion 17 is also included on the top of the peg 5.

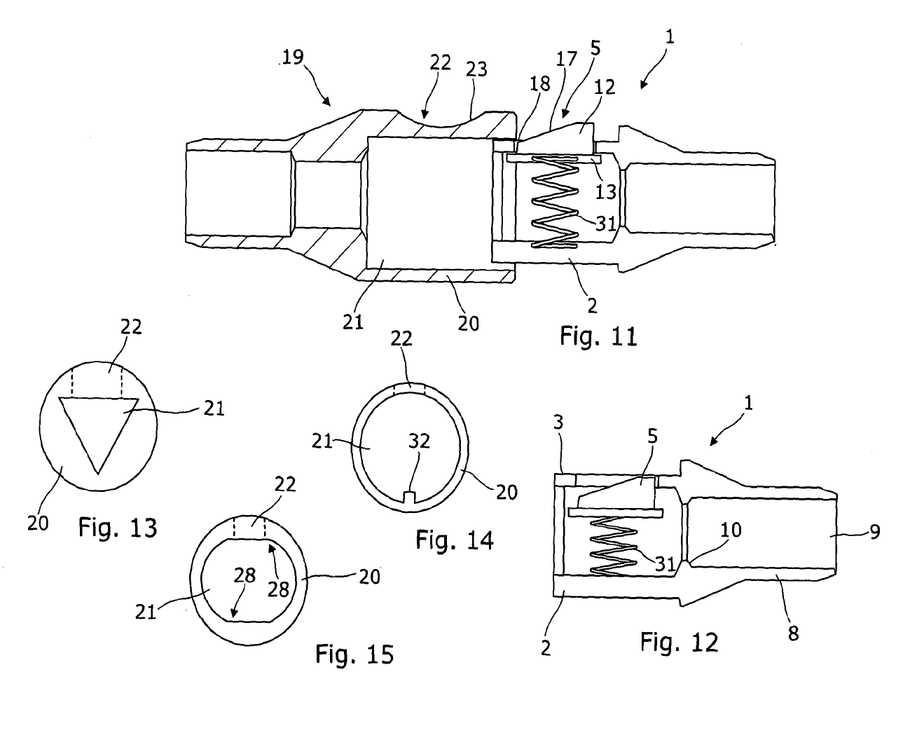

FIG. 11 illustrates, in axial cross-sectional view, a male connector 1 and a female connector 19 in a configuration ready for connection. The male mating part 2 of the male connector 1 is inserted into the end of cavity 21 of the female mating part 20. The leading edge 18 of the protruding button 12 of the locking peg 5 is located at, or just below, the surface of the male mating part such that when the two connectors are pushed together, the edge of the cavity of the female connector interacts with the sloping portion 17 or the peg 5, and causing it to more down into the body of the male connector against the biasing force of the spring 31, allowing the connectors to be pushed together. Once the male connector 1 is inserted into the female connector, the biasing element 31 urges the peg into engagement with the hole 22 in the female connector thereby releasable locking the two connectors together.

FIG. 12 illustrates, in axial cross-sectional view, a male connector 1 according to the present invention, and illustrating the locking peg 5 in its depressed second position, biased against the spring 31, and where the outer surface of the peg 5 is substantially flush with the surface 3 of the male mating section 2.

FIG. 13 illustrates an alternative cross-section of the cavity 21 of a female connector 19 in which the cavity 21 in the female mating section 20 is of triangular cross-section. This shape, in combination with a corresponding triangular section male mating section would also achieve the non-rotatable connection desired.

FIG. 14 illustrates a further alternative non-circular cross-section of the cavity 21 of a female connector 19 in which the cavity 21 is essentially circular but is fitted with an internal pin or ridge 32 that can mate with a corresponding groove on a male mating portion of a male connector thereby achieving the non-rotatable connection desired.

FIG. 15 illustrates a yet further embodiment of a non-circular cavity 21 in a female meting portion 20 of a female connector. In this embodiment, two flat faces 28 are provided on an otherwise generally circular cavity. Again, however, this achieves the desired object of forming a non-rotatable connection.

It is clear that the shaft connectors provided by the invention can be used not only to couple shafts but also to attach a shaft (or a shaft array) to, at one end, a head device (that is used to clean/unblock a conduit), wherein such a head device comprises a female connector, and/or to, at the other end, a component that facilitates the application of rotational force (e.g. a drill bit, to be connected to a power drill), wherein such a component comprises a male connector.

1.-12. (canceled)

13. A male shaft connector for connecting manually- or mechanically-driven rotating shafts, the male connector comprising:
a male mating section having a non-circular external cross-section perpendicular to an axis of a shaft to be connected;
a locking peg located within an aperture in the male mating section and moveable between a first position wherein the peg protrudes from a surface of the mating section and a second position wherein an outermost surface of the peg is substantially flush with the surface of the male mating section;
a biasing element to bias the peg towards the first position; and
a shaft mounting section attached to the male mating section.

14. A male connector according to claim 13 wherein a protruding surface of the peg includes an angled portion such that an edge of the peg furthest from the shaft mounting section is substantially flush with, or recessed below, the surface of the male mating section such that insertion of the male mating section into a cavity of a corresponding female mounting section causes the peg to move towards its second position.

15. A male connector according to claim 13 wherein a protruding surface of the peg includes a flat portion perpendicular to an axis of movement of the peg between its first and second positions.

16. A male connector according to claim 13 wherein the cross-section of the male mating section perpendicular to the axis of a shaft to be connected comprises a circle with a missing segment.

17. A male connector according to claim 16 wherein the locking peg is located on a flat portion of the male mating section corresponding to a chord defining the missing segment.

18. A male connector according to claim 13 wherein faces of the locking peg parallel to the axis of a shaft to be connected comprise flat surfaces.

19. A male connector according to claim 13 wherein a face of the locking peg perpendicular to the axis of a shaft to be connected, and furthest away from the shaft mounting section comprises a flat surface.

20. A female shaft connector for connecting manually- or mechanically-driven rotating shafts, the female connector comprising:
a shaft mounting section;
a female mating section comprising a cavity to receive a male mating section from a corresponding male shaft connector, the cavity having a non-circular cross-section perpendicular to an axis of a shaft to be connected; and,
an aperture extending from an interior of the cavity to an exterior of the female mating section to receive a locking peg from a corresponding male shaft connector.

21. A female connector according to claim 20 wherein the aperture has a non-circular cross-section and comprises a circle with a missing segment.

22. A shaft connection system comprising:
a male shaft connector comprising:
a male mating section having a non-circular external cross-section perpendicular to an axis of a shaft to be connected;
a locking peg located within an aperture in the male mating section and moveable between a first position wherein the peg protrudes from a surface of the mating section and a second position wherein an outermost surface of the peg is substantially flush with the surface of the male mating section;
a biasing element to bias the peg towards the first position; and
a shaft mounting section attached to the male mating section; and
a female shaft connector comprising:
a shaft mounting section;
a female mating section comprising a cavity to receive a male mating section from a corresponding male shaft connector, the cavity having a non-circular cross-section perpendicular to an axis of a shaft to be connected; and
an aperture extending from an interior of the cavity to an exterior of the female mating section to receive a locking peg from a corresponding male shaft connector;
wherein each of the male shaft connector and female shaft connector has a correspondingly shaped mating section.

23. A shaft comprising:
an elongate shaft member;
a male shaft connector to one end of the shaft member, wherein the male shaft connector comprises:
a male mating section having a non-circular external cross-section perpendicular to an axis of a shaft to be connected;
a locking peg located within an aperture in the male mating section and moveable between a first position wherein the peg protrudes from a surface of the mating section and a second position wherein an outermost surface of the peg is substantially flush with the surface of the male mating section;
a biasing element to bias the peg towards the first position; and
a female shaft connector affixed to the other end of the shaft member, wherein the female shaft connector comprises:
a shaft mounting section;
a female mating section comprising a cavity to receive a male mating section from a corresponding male shaft connector, the cavity having a non-circular cross-section perpendicular to an axis of a shaft to be connected; and
an aperture extending from an interior of the cavity to an exterior of the female mating section to receive a locking peg from a corresponding male shaft connector.
